(19) United States
(12) Patent Application Publication
(10) Pub. No.: US 2026/0302293 A1
(43) Pub. Date: Oct. 1, 2026

(54) FUEL CELL SYSTEM

(71) Applicants: AISAN KOGYO KABUSHIKI KAISHA, Obu-shi (JP); TOYOTA JIDOSHA KABUSHIKI KAISHA, Toyota-shi (JP)

(72) Inventors: Hiroki KOBAYASHI, Miyoshi-shi (JP); Kazunori ITO, Nagoya-shi (JP); Seiichi TANAKA, Nagoya-shi (JP); Tsuyoshi MARUO, Okazaki-shi (JP)

(73) Assignees: AISAN KOGYO KABUSHIKI KAISHA, Obu-shi (JP); TOYOTA JIDOSHA KABUSHIKI KAISHA, Toyota-shi (JP)

(21) Appl. No.: 19/554,274

(22) Filed: Mar. 2, 2026

(30) Foreign Application Priority Data
Mar. 28, 2025 (JP) 2025-055050

(51) Int. Cl. H01M 8/04746; H01M 8/04082; H01M 8/04089; H01M 8/04223; H01M 8/0432

(52) U.S. Cl. CPC H01M 8/04753; H01M 8/04097; H01M 8/04201; H01M 8/04253; H01M 8/04358

(57) ABSTRACT

A fuel cell system includes a controller for controlling a linear solenoid valve and an injector, and a temperature sensor for measuring the outside temperature or the temperature of refrigerant that cools an FC stack. When supplying hydrogen gas to the FC stack while a measurement value of the temperature sensor is equal to or less than a predetermined temperature, the controller causes a linear solenoid valve to inject hydrogen gas while maintaining the opening degree of the linear solenoid valve at a predetermined temperature and simultaneously causes the injector to intermittently inject hydrogen gas.

### CROSS-REFERENCE TO RELATED APPLICATIONS

This application is based upon and claims the benefit of priority to Japanese Patent Application No. 2025-055050 filed on Mar. 28, 2025, the entire contents of which are incorporated herein by reference.

### BACKGROUND

### Technical Field

The present disclosure relates to a fuel cell system including a fuel cell that generates power by receiving supply of fuel gas and oxidant gas.

### Related Art

As a device for supplying fuel (gaseous fuel) to a fuel cell, Japanese unexamined patent application publication No. 2020-087520 (JP 2020-087520A) discloses a fuel cell system including a linear solenoid valve, an injector, and an ejector.

### SUMMARY

### Technical Problems

For a fuel cell system, for example, the power generation efficiency of a fuel cell tends to decrease under low temperatures. It is therefore desirable to increase a supply flow rate of fuel to be supplied to the fuel cell as much as possible. Further, if a circulation flow rate of fuel circulated from a fuel cell back to an ejector is too high, water vapor (generated water) contained in the circulated fuel may freeze in an ejection port of the ejector. On the other hand, if the circulation flow rate of fuel circulated from the fuel cell back to the ejector is too low, fuel shortage may locally occur inside the fuel cell, potentially leading to deterioration of the fuel cell. Therefore, it is required to ensure both an appropriate supply flow rate of fuel to the fuel cell and an appropriate circulation flow rate of fuel to the ejector under low-temperature conditions. Furthermore, it is also desirable to maintain the durability of devices for supplying fuel to a fuel cell, such as a linear solenoid valve.

The above document, JP2020-087520A, discloses that when frost forms inside an ejector, after a lapse of a predetermined time from when the fuel is injected by the linear solenoid valve, the fuel is intermittently injected by the injector, thereby vibrate and blow off the frost adhering inside the ejector. However, JP2020-087520A fails to disclose the configuration ensuring both an appropriate supply flow rate of fuel to the fuel cell and an appropriate circulation flow rate of fuel to the ejector under low temperatures as described above.

The disclosure has been made to address the above problems and has a purpose to provide a fuel cell system capable of ensuring both an appropriate supply flow rate of fuel to a fuel cell and an appropriate circulation flow rate of fuel back to an ejector while maintaining the durability of a fuel injection device, under low temperatures.

### Means of Solving the Problems

To achieve the above purposes, one aspect of the present disclosure provides a fuel cell system including: a fuel cell; a fuel supply passage for supplying fuel to the fuel cell; an ejector provided in the fuel supply passage; a first fuel injection device configured to inject the fuel into the ejector while maintaining an arbitrary opening degree between a fully-closed opening degree and a fully-open opening degree; a second fuel injection device configured to intermittently inject the fuel into the ejector; a fuel circulation passage for circulating unused fuel discharged from the fuel cell back to the ejector, which is a part of the fuel supplied to the fuel cell; a controller for controlling the first fuel injection device and the second fuel injection device; and a temperature measurement part for measuring an outside temperature or a temperature of refrigerant that cools the fuel cell, wherein when supplying the fuel to the fuel cell while a measurement value of the temperature measurement part is equal to or less than a predetermined temperature, the controller causes the first fuel injection device to inject the fuel while maintaining an opening degree of the first fuel injection device at a predetermined opening degree, and simultaneously causes the second fuel injection device to intermittently inject the fuel.

According to this configuration, when the first fuel injection device and the second fuel injection device inject fuel into the ejector under low temperatures, the opening degree of the first fuel injection device is maintained at the predetermined opening degree. This allows the fuel to be injected into the ejector while reducing the impact on the durability of the first fuel injection device. Furthermore, intermittently injecting the fuel from the second fuel injection device can increase the flow velocity of fuel to be supplied to the fuel cell. This promotes the circulation of fuel from the fuel cell back to the ejector. Under low temperatures, therefore, this configuration can simultaneously ensure an appropriate supply flow rate of fuel to be supplied to the fuel cell through the fuel supply passage and an appropriate circulation flow rate of fuel to be circulated from the fuel cell back to the ejector, while maintaining the durability of the first fuel injection device.

In the above-described configuration, the first fuel injection device may be a linear solenoid valve, and the second fuel injection device is an injector.

According to this configuration, the fuel is injected into the ejector under low temperatures while the opening degree of the linear solenoid valve is maintained at the predetermined opening degree. This can suppress wear of a sliding portion in the linear solenoid valve (e.g., an area where a valve element slides) and maintain the sealing performance of a valve part in the linear solenoid valve (e.g., between the valve element and a valve seat). Under low temperatures, therefore, this configuration can simultaneously ensure the supply flow rate of fuel to be supplied to the fuel cell and the circulation flow rate of fuel to be circulated to the ejector, while maintaining the durability of the linear solenoid valve.

The fuel cell system of the present disclosure can achieve both an appropriate supply flow rate of fuel to a fuel cell and an appropriate circulation flow rate of fuel to an ejector while maintaining the durability of a fuel injection device.

### BRIEF DESCRIPTION OF THE DRAWINGS

FIG. 1 is a schematic configuration diagram of a fuel cell system in an embodiment;

FIG. 2 is a graph showing one example of temporal changes in an opening degree of an injector driven by pulse control;

FIG. 3 is a graph showing one example of temporal change in an opening degree of a linear solenoid valve driven by opening-degree control;

FIG. 4 is a graph showing one example of a relationship between a supply flow rate of fuel supplied to a fuel cell and a circulation flow rate of fuel circulated to an ejector in the embodiment;

FIG. 5 is a graph showing one example of a relationship between a supply flow rate of fuel supplied to a fuel cell and a circulation flow rate of fuel circulated to an ejector in a first comparative example; and

FIG. 6 is a graph showing one example of a relationship between a supply flow rate of fuel supplied to a fuel cell and a circulation flow rate of fuel circulated to an ejector in a second comparative example.

### DETAILED DESCRIPTION OF THE EXEMPLARY EMBODIMENTS

A detailed description of an embodiment of a fuel cell system of the present disclosure will now be given referring to the accompanying drawings.

### Overview of Fuel Cell System

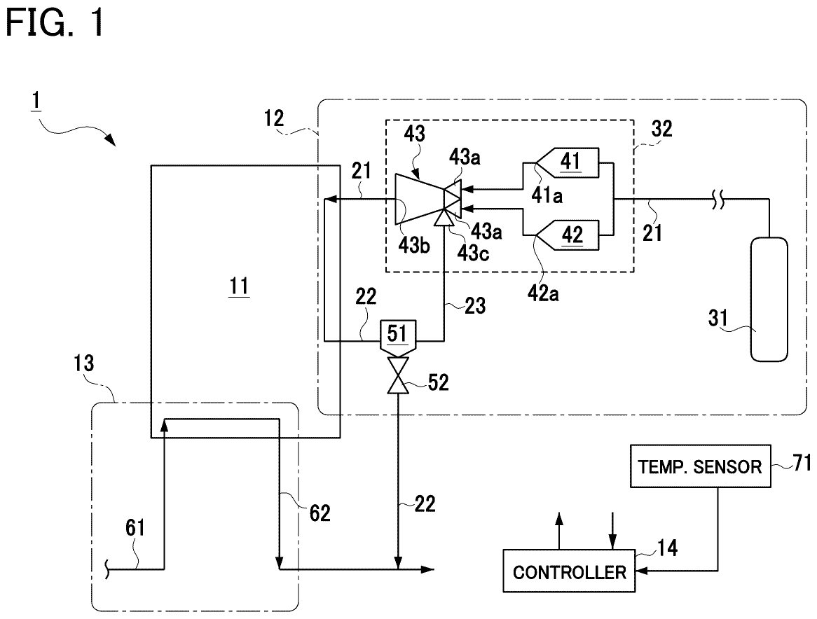

The overview of a fuel cell system 1 in the present embodiment will be described first. This fuel cell system 1 includes an FC stack 11, a hydrogen system 12, an air system 13, and a controller 14, as shown in FIG. 1. The FC stack 11 is one example of a “fuel cell” of the disclosure.

The FC stack 11 generates electricity, or electric power, by receiving fuel gas and oxidant gas supplied thereto. In the present embodiment, the fuel gas is hydrogen gas, and the oxidant gas is air. In other words, the FC stack 11 generates electric power from the hydrogen gas supplied from the hydrogen system 12 and the air supplied from the air system 13. The hydrogen gas is one example of “fuel” in the present disclosure.

The hydrogen system 12 is provided on the anode side of the FC stack 11. This hydrogen system 12 is provided with a hydrogen supply passage 21, a hydrogen exhaust passage 22, and a hydrogen circulation passage 23. The hydrogen supply passage 21 is a channel for supplying hydrogen gas from a hydrogen tank 31 to the FC stack 11. The hydrogen exhaust passage 22 is a channel for exhausting unused hydrogen gas discharged from the FC stack 11 (hereinafter, referred to as “hydrogen off-gas”), which is a part of the hydrogen gas supplied to the FC stack 11, to the outside of the fuel cell system 1. The hydrogen circulation passage 23 is a channel for circulating at least part of the hydrogen off-gas from the hydrogen exhaust passage 22 back to an ejector 43, which is mentioned later, provided in the hydrogen supply passage 21. The hydrogen supply passage 21 is one example of a “fuel supply passage” of the present disclosure. The hydrogen circulation passage 23 is one example of a “fuel circulation passage” of the present disclosure.

In the hydrogen supply passage 21, a fuel supply device 32 is provided to supply the hydrogen gas from the hydrogen tank 31 to the FC stack 11. This fuel supply device 32 includes a linear solenoid valve 41 (LSV), an injector 42 (INJ), and an ejector 43. The linear solenoid valve 41 is one example of a “first fuel injection device” of the present disclosure, and the injector 42 is one example of a “second injection device” of the present disclosure.

The linear solenoid valve 41 includes an injection port 41a and is configured to open and close this injection port 41a by driving a linear solenoid (not shown). This linear solenoid valve 41 is controlled to maintain the opening degree of the injection port 41a at an arbitrary opening degree between a fully-closed opening degree (an opening degree of 0%) and a fully-open opening degree (an opening degree of 100%) to inject hydrogen gas into the ejector 43.

The injector 42 includes an injection port 42a and is configured to adjust the opening degree of the injection port 42a only to a fully-closed opening degree or a fully-open opening degree and to intermittently inject hydrogen gas into the ejector 43.

The ejector 43 is positioned in the hydrogen supply passage 21, downstream of the linear solenoid valve 41 and the injector 42, i.e., downstream of the flowing direction of hydrogen gas flowing in the hydrogen supply passage 21, and upstream of the FC stack 11, i.e., upstream of the flowing direction of hydrogen gas flowing in the hydrogen supply passage 21. The ejector 43 includes inlets 43a, an outlet 43b, and a suction port 43c.

The inlets 43a are inflow ports through which hydrogen gas from the linear solenoid valve 41 and the injector 42 is injected into the ejector 43. In the example shown in FIG. 1, one of the inlets 43a is connected to the injection port 41a of the linear solenoid valve 41 and the other inlet 43a is connected to the injection port 42a of the injector 42. Further, the outlet 43b is an ejection port for discharging hydrogen gas, and connected to the FC stack 11. In addition, the suction port 43c is a port for suctioning hydrogen off-gas and connected to the hydrogen circulation passage 23.

This ejector 43 is configured to suck the hydrogen off-gas, discharged from the FC stack 11 into the hydrogen exhaust passage 22, through the suction port 43c via the hydrogen circulation passage 23 connected to the hydrogen exhaust passage 22, by the negative pressure created when the hydrogen gas injected from the linear solenoid valve 41 and the injector 42 is delivered into the ejector 43 through the inlets 43a. Further, the ejector 43 combines the hydrogen off-gas drawn in through the suction port 43c with the hydrogen gas delivered through the inlets 43a, and recirculates such mixed gas through the outlet 43b to the FC stack 11. In this manner, the hydrogen off-gas discharged from the FC stack 11 into the hydrogen exhaust passage 22 is circulated to the FC stack 11 via the ejector 43.

Further, in the hydrogen exhaust passage 22, a gas-liquid separator 51 and an exhaust-drain valve 52 are provided. The gas-liquid separator 51 is a device for separating moisture or water from the hydrogen off-gas. The gas-liquid separator 51 is connected to the suction port 43c of the ejector 43 via the hydrogen circulation passage 23. The exhaust-drain valve 52 is configured to control exhaust of the hydrogen off-gas discharged from the FC stack 11 to the outside, and switch between exhausting and blocking the hydrogen off-gas and moisture or water from the gas-liquid separator 51 into an air exhaust passage 62, mentioned later, of the air system 13.

The air system 13 is provided on a cathode side of the FC stack 11. This air system 13 includes an air supply passage 61 and an air exhaust passage 62. The air supply passage 61 is a channel for supplying air from outside of the fuel cell system 1 to the FC stack 11. The air exhaust passage 62 is a channel for exhausting the air discharged from the FC stack 11 (hereinafter, referred to as “air off-gas”) to the outside of the fuel cell system 1.

In the present embodiment, the fuel cell system 1 has a temperature sensor 71 for measuring the temperature of outside air or the temperature of refrigerant that cools the FC stack 11. The temperature sensor 71 is one example of a “temperature measurement part” of the present disclosure.

The controller 14 includes, for example, an arithmetic processing unit, such as a CPU, a storage unit, such as ROM that stores control programs and control data to be processed by the CPU and RAM used as various working areas for control processing, and an input/output interface unit. The controller 14 performs various controls of the fuel cell system 1 according to the control programs stored in the storage unit.

Specifically, the controller 14 performs, for example, the control of maintaining the opening degree of the injection port 41a of the linear solenoid valve 41 at an arbitrary opening degree, and the control of switching the opening degree of the injection port 42a of the injector 42 between the fully-closed opening degree and the fully-open opening degree. Furthermore, the controller 14 also controls the exhaust-drain valve 52 and others. The controller 14 is configured to receive data on measurement values from the temperature sensor 71.

In the fuel cell system 1 configured as above, the hydrogen system 12 is configured such that the hydrogen gas supplied to the FC stack 11 through the hydrogen supply passage 21 is used for power generation in the FC stack 11, and then discharged as hydrogen off-gas from the FC stack 11 to the outside via the hydrogen exhaust passage 22 or suctioned into the ejector 43 via the hydrogen exhaust passage 22 and the hydrogen circulation passage 23. The air system 13 is configured such that the air supplied to the FC stack 11 through the air supply passage 61 is used for power generation in the FC stack 11, and then discharged as air off-gas from the FC stack 11 to the outside via the air exhaust passage 62.

### Control of Linear Solenoid Valve and Injector under Low Temperatures

In the fuel cell system 1 configured as above, under low temperatures, the power generation efficiency of the FC stack 11 tends to decrease, and a supply flow rate of hydrogen gas to be supplied to the FC stack 11 is desired to increase in order to increase the volume of hydrogen in the FC stack 11 to enhance the power generation efficiency.

Moreover, under low temperatures, if the circulation flow rate of hydrogen gas (specifically, hydrogen off-gas) to the ejector 43 is too high, moisture or water vapor (generated water) contained in the circulated hydrogen gas may freeze in the ejector 43 (e.g., the outlet 43b). On the other hand, under low temperatures, if the circulation flow rate of hydrogen gas to the ejector 43 is too low, hydrogen may become deficient locally inside the FC stack 11, potentially leading to deterioration of the FC stack 11.

The term “under low temperatures” refers to a condition that the outside temperature or the temperature of refrigerant for cooling the FC stack 11 is equal to or less than a predetermined temperature PT (i.e., a temperature at which freezing may occur inside the ejector 43; for example, 0° C.), specifically, refers to a low-temperature start-up condition or a low-temperature low load condition. This low-temperature start-up condition indicates the condition where, for example, a start switch of a vehicle equipped with the fuel cell system 1 is turned ON, initiating power generation in the FC stack 11 at low temperatures. The low-temperature low-load condition indicates the condition where, for example, the FC stack 11 generates power, under low temperatures, while a vehicle equipped with the fuel cell system 1 is traveling at low speeds.

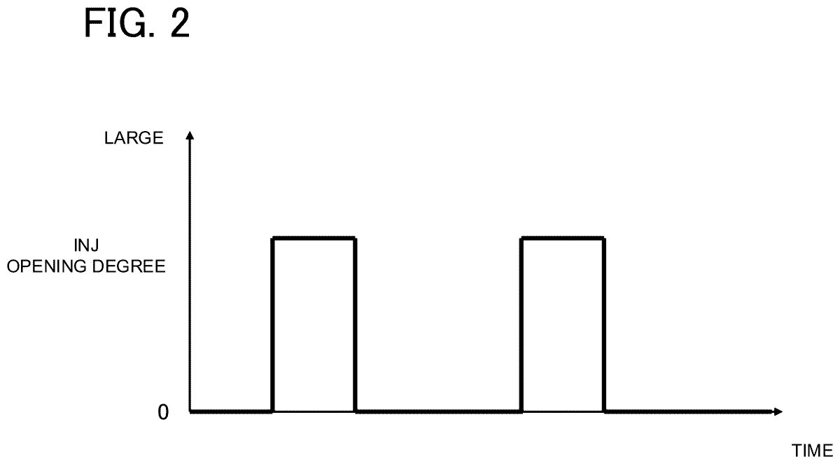

Therefore, for controlling the linear solenoid valve 41 and the injector 42 to regulate the supply flow rate of hydrogen gas to the FC stack 11 and the circulation flow rate of hydrogen gas to the ejector 43 during the low-temperature conditions, the first comparative example will be considered, in which the linear solenoid valve 41 is stopped, while only the injector 42 is driven by pulse control as shown in FIG. 2, i.e., by the control that switches the injector 42 between the fully-open opening degree and the fully-closed opening degree at fixed intervals.

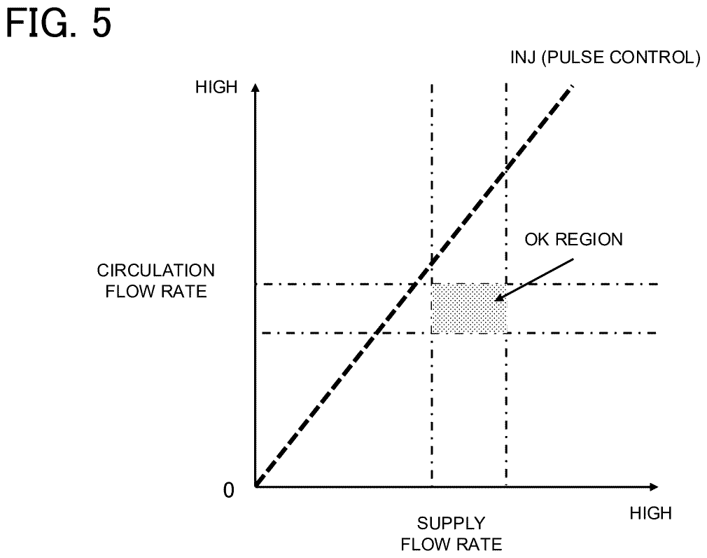

In this case, when the injector 42 is driven by the pulse control, the circulation flow rate of hydrogen gas to the ejector 43 is apt to significantly increase compared with the supply flow rate of hydrogen gas to the FC stack 11. Thus, as shown in FIG. 5, it is difficult to regulate the supply flow rate of hydrogen gas to the FC stack 11 (simply denoted as “Supply flow rate” in the figure) and the circulation flow rate of hydrogen gas to the ejector 43 (simply denoted as “Circulation flow rate” in the figure) to fall within an appropriate range (denoted as “OK region” in the figure). Consequently, the circulation flow rate of hydrogen gas to the ejector 43 may become excessively high, which may cause freezing in the ejector 43 due to moisture vapor contained in the hydrogen gas circulated back to the ejector 43.

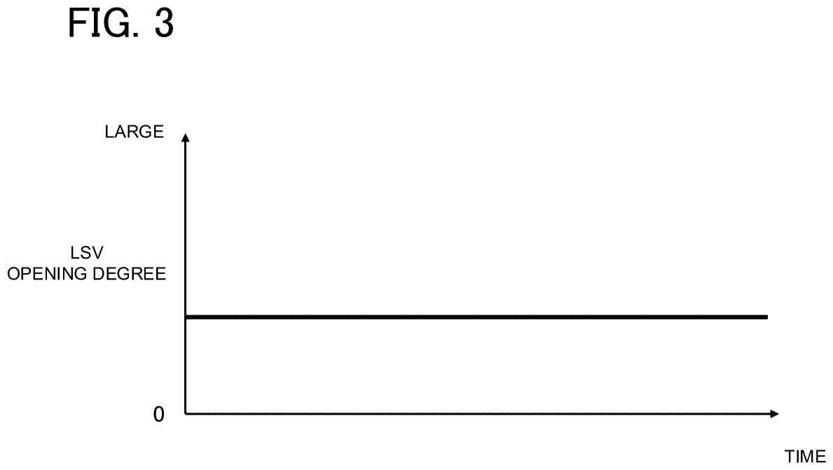

Furthermore, a second comparative example will be considered, in which the injector 42 is stopped, while only the linear solenoid valve 41 is driven by opening-degree control as shown in FIG. 3, i.e., by the control that maintains the linear solenoid valve 41 at the predetermined opening degree PO.

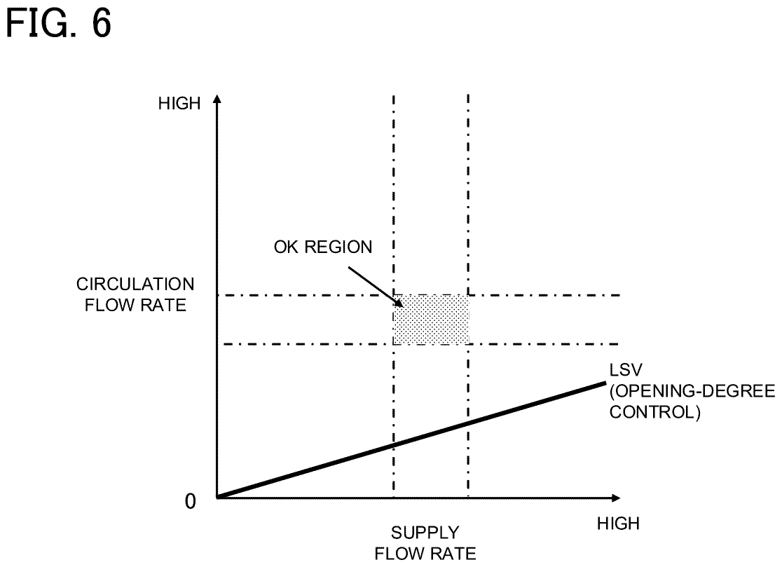

In this case, when the linear solenoid valve 41 is driven by the opening-degree control, the circulation flow rate of hydrogen gas to the ejector 43 is apt to significantly decrease compared with the supply flow rate of hydrogen gas to the FC stack 11. It is therefore difficult to regulate the supply flow rate of hydrogen gas to the FC stack 11 (simply denoted as “Supply flow rate” in the figure) and the circulation flow rate of hydrogen gas to the ejector 43 (simply denoted as “Circulation flow rate” in the figure) to fall within an appropriate range (denoted as “OK region” in the figure) as shown in FIG. 6. Consequently, the circulation flow rate of hydrogen gas to the ejector 43 may become excessively low, resulting in a low supply flow rate of hydrogen gas to the FC stack 11. This may cause decrease the power generation efficiency of the FC stack 11 or partial shortage, or deficiency, of hydrogen in the FC stack 11, leading to deterioration of the FC stack 11.

In the present embodiment, therefore, to regulate the supply flow rate of hydrogen gas to the FC stack 11 and the circulation flow rate of hydrogen gas to the ejector 43 under low temperatures, the controller 14 performs the opening-degree control shown in FIG. 3 for the linear solenoid valve 41 and performs the pulse control shown in FIG. 2 for the injector 42.

Specifically, when supplying hydrogen gas to the FC stack 11 during the low-temperature condition where the measurement value received from the temperature sensor 71 is the predetermined temperature PT or less, the controller 14 causes the linear solenoid valve 41 to inject hydrogen gas while maintaining the opening degree of the linear solenoid valve 41 at the predetermined opening degree PO and simultaneously causes the injector 42 to intermittently inject hydrogen gas.

In this manner, during injection of hydrogen gas into the ejector 43 from the linear solenoid valve 41 and the injector 42 under low temperatures, the opening degree of the linear solenoid valve 41 is maintained at the predetermined opening degree PO. Thus, the number of opening and closing operations of the injection port 41a of the linear solenoid valve 41 can be reduced. This can suppress wear of a sliding portion in the linear solenoid valve 41 (e.g., an area where a valve element slides) and maintain the sealing performance of a valve part in the linear solenoid valve 41 (e.g., between the valve element and a valve seat). This configuration can therefore inject hydrogen gas to the ejector 43 while reducing the impact on the durability of the linear solenoid valve 41. Moreover, since hydrogen gas is intermittently injected from the injector 42, it is possible to inject the hydrogen gas into the ejector 43 while increasing the flow velocity of hydrogen gas to be supplied to the FC stack 11.

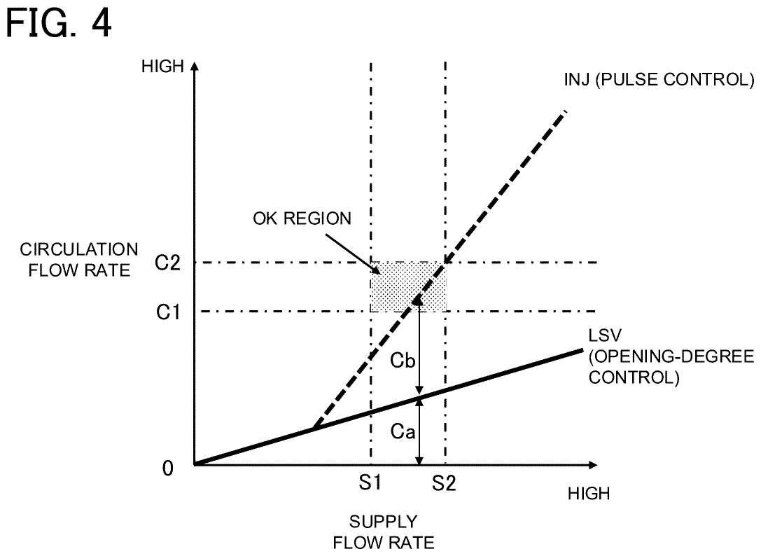

Consequently, under low temperatures, as shown in FIG. 4, it is possible to regulate the supply flow rate of hydrogen gas to the FC stack 11 (denoted simply as “Supply flow rate” in the figure) and the circulation flow rate of hydrogen gas to the ejector 43 (denoted simply as “Circulation flow rate” in the figure) to fall within an appropriate range. This range is denoted as “OK region” in the figure, where the supply flow rate is S1 or higher and S2 or less, and further the circulation flow rate is C1 or higher and C2 or less.

Specifically, when the linear solenoid valve 41 is driven by the opening-degree control and the injector 42 is driven by the pulse control, while regulating the supply flow rate of hydrogen gas to the FC stack 11 into a range from S1 to S2, the circulation flow rate of hydrogen gas to the ejector 43 can be regulated into a range from C1 to C2 by adding a circulation flow rate Cb of hydrogen gas to the ejector 43, obtained by driving of the injector 42, to a circulation flow rate Ca of hydrogen gas to the ejector 43, obtained by driving of the linear solenoid valve 41.

Accordingly, under low temperatures, the fuel cell system can ensure an appropriate supply flow rate of hydrogen gas to be supplied to the FC stack 11 through the hydrogen supply passage 21 and simultaneously ensure an appropriate circulation flow rate of hydrogen gas to be circulated from the FC stack 11 back to the ejector 43, while maintaining the durability of the linear solenoid valve 41.

Since the supply flow rate of hydrogen gas to the FC stack 11 can be increased under low temperatures as above, the power generation efficiency of the FC stack 11 can be enhanced. In addition, since the circulation flow rate of hydrogen gas to the ejector 43 can be regulated into an appropriate range, it is possible to prevent the occurrence of freezing inside the ejector 43 due to moisture vapor contained in the circulated hydrogen gas and also prevent deterioration of the FC stack 11 due to partial deficiency of hydrogen inside the FC stack 11.

The foregoing embodiments are mere examples and give no limitation to the disclosure. The disclosure may be embodied in other specific forms without departing from the essential characteristics thereof.

### REFERENCE SIGNS LIST

1 Fuel cell system
11 FC stack
12 Hydrogen system
13 Air system
14 Controller
21 Hydrogen supply passage
22 Hydrogen exhaust passage
23 Hydrogen circulation passage
32 Fuel supply device
41 Linear solenoid valve (LSV)
41a Injection orifice
42 Injector (INJ)
42 Injection orifice
43 Ejector
71 Temperature sensor
PT Predetermined temperature
PO Predetermined opening degree

What is claimed is:

1. A fuel cell system comprising:
a fuel cell;
a fuel supply passage for supplying fuel to the fuel cell;
an ejector provided in the fuel supply passage;
a first fuel injection device configured to inject the fuel into the ejector while maintaining an arbitrary opening degree between a fully-closed opening degree and a fully-open opening degree;
a second fuel injection device configured to intermittently inject the fuel into the ejector;
a fuel circulation passage for circulating unused fuel discharged from the fuel cell back to the ejector, which is a part of the fuel supplied to the fuel cell;
a controller for controlling the first fuel injection device and the second fuel injection device; and
a temperature measurement part for measuring an outside temperature or a temperature of refrigerant that cools the fuel cell,
wherein when supplying the fuel to the fuel cell while a measurement value of the temperature measurement part is equal to or less than a predetermined temperature, the controller causes the first fuel injection device to inject the fuel while maintaining an opening degree of the first fuel injection device at a predetermined opening degree, and simultaneously causes the second fuel injection device to intermittently inject the fuel.

2. The fuel cell system according to claim 1, wherein
the first fuel injection device is a linear solenoid valve, and
the second fuel injection device is an injector.
